(19) United States
(12) Patent Application Publication
(10) Pub. No.: US 2005/0265558 A1
(43) Pub. Date: Dec. 1, 2005

(54) Method and circuit for enhancement of stereo audio reproduction

(75) Inventor: Itai Neoran, Beit-Hannanya (IL)

Correspondence Address: BROWDY AND NEIMARK, P.L.L.C.;624 NINTH STREET, NW, SUITE 300, WASHINGTON, DC, 20001-5303, US

(73) Assignee: Waves Audio Ltd., Tel Aviv (IL)

(21) Appl. No.: 11/130,394

(22) Filed: May 17, 2005

Related U.S. Application Data
(60) Provisional application No. 60/571,515, filed on May 17, 2004.

(51) Int. Cl. H04R 5/00; H04R 5/02

(52) U.S. Cl. 381/17; 381/309; 381/63

(57) ABSTRACT

Some embodiments of the present invention relate to a method and a circuit for processing an audio signal. In accordance with some embodiments of the present invention, there is provided an audio processing circuit including a first signal path, a second signal path and an output adder. The first signal path may be configured to allow an input signal to pass through the audio processing circuit substantially unaffected. The second signal path may include a reverberation filter and a cross-talk cancellation filter adapted to receive an output of the reverberation filter directly or indirectly. The audio processing circuit may further include an output adder, and the output adder may be adapted to receive and combine the output of the direct signal path and the output of the second signal path.

### FIELD OF THE INVENTION

The present invention relates to reproduction of stereophonic audio using two loudspeakers. More specifically, the invention relates a system, a method and a circuit for enhancing stereo reproduction in cases where certain physical attributes associated with the loudspeakers may hamper stereophonic performance.

### BACKGROUND OF THE INVENTION

Provided below is a list of conventional terms. For each of the terms below a short definition is provided in accordance with each of the term's conventional meaning in the art. The terms provided below are known in the art and the following definitions are provided for convenience purposes. Accordingly, unless stated otherwise, the definitions below shall not be binding and the following terms should be construed in accordance with their usual and acceptable meaning in the art.

Phantom Image—The virtual sound-source generated in reproduction of stereo sound via two or more loudspeakers. A phantom image may be located in front or behind a listener.

Stereo Image—The totality of phantom images in stereo reproduction, including images in the rear of the listener.

Panning—The act or process of manipulating the phantom image direction of a monophonic source in stereo reproduction by routing the mono signal into both channels of the stereo, and by manipulating some parameters of the signal, such as the relative amplitudes of the channels or their relative phase or delays.

Stereo width—The perceived angular span between the leftmost and the rightmost phantom images in a stereo image.

Width matrix—A technique known in the art for controlling the stereo width.

HRTF—Head Related Transfer Function is a mathematical model which is known in the art for simulating some aspects of the propagation of sound through the air in a certain environment.

Binaural recording—A known stereo recording technique, which as part of which microphones are placed on an artificial (dummy) human head.

Ipsilateral Transfer Function—A known mathematical model used to simulate some aspects of the diffraction of sound by the (human) head, measured at the ear closer to a given sound source.

Contralateral Transfer Function—A known mathematical model used to simulate some aspects of the diffraction of sound by the head, measured at the ear distant from a given sound source.

Interaural Transfer Function (ITF)— A known mathematical model used to simulate some aspects of the diffraction of sound by the head shadowing, described for a given source location by computing the ratio of the frequency responses at the two ears.

Cross-Talk Cancellation—A method for stereo monitoring using two or more loudspeakers, designed to substantially prevent sound or audio information from side loudspeakers from reaching an opposite listeners ear (the ear which is opposite (at least to some degree) to that loudspeaker(s) location). Cross-Talk Cancellation is typically attained through the use of various signal processing techniques to calculate an acoustic signal which is intended to cancel out the cross-talk between loudspeakers located on opposite sides, and adding that acoustic signal to each of the relevant loudspeakers' output.

Dipole filter/Dipole processing—A stereo cross-talk cancellation method designed and typically used in cases where the loudspeakers are substantially closely-spaced and are similar or identical.

Sweet-Spot—The area of best head position, in which listening to stereo or surround reproduction via loudspeakers is considered to be optimal and where the stereo/surround effect is well perceived.

Direct sound—In a room: the shortest sound path between the source and the listener not reflecting from any wall or object. In the field of electronic audio processing: direct sound relates to the unprocessed sound path.

Reverberation (filter)—A linear or non-linear filter adapted to create a simulation of acoustic behavior within a (certain) surrounding space, typically, but not necessarily, including simulation of reflections from walls and objects. Some kinds of reverberation filters may implement convolution of the input signal or preprocessed derivative of the input signal with pre-recorded impulse-response.

Crossover filter—A set of two or more filters, separating the frequency domain into bands, where the sum of the frequency responses of all the filters is an all-pass filter.

Conventional reproduction of stereophonic audio on two loudspeakers dates back to the 30's with the invention of Blumlein stereo (British Pat. No. 394925). In accordance with the teachings of Blumlein an audio signal is recorded and transmitted as a set of two channels, allowing each of two synchronized loudspeakers to reproduce a different audio signal, where the phase differences and amplitude differences between the two signals generate imaginary sound-source locations at the listener's ears. The imaginary sound-sources are referred to in the art as ‘phantom images’. The totality of phantom images is commonly referred to as the ‘stereo image’.

The invention of stereo and phantom images revolutionized audio reproduction technologies. For example, by maintaining certain relations between the signals in the two stereo channels, the perceived direction of each phantom-image could be designated such that it closely corresponds to the direction of the real source in the recorded acoustic environment, as long as that direction is not left of the leftmost loudspeaker or right of the rightmost loudspeaker. Using stereo related technology it is also possible to generate a stereo signal from a mono signal (one channel), in a way that the mono sound source will appear as a phantom image in a desired direction, by simply routing the mono signal into both channels of the stereo, and by manipulating the relative amplitudes of the channels or their relative delays. The latter method is commonly referred to as ‘panning’ and is described in greater detail in Griesinger D., Stereo and Surround panning in practice, 112 Audio engineering society convention, Germany 2002 (hereinafter “Griesinger”).

In conventional stereo, the perceived direction of a phantom image in steady-state sound is determined by the phase-difference between the channels in low frequencies, and by the amplitude differences between the channels in high frequencies, as is described in greater detail in Bernfeld B., Attempts for better understanding of the directional stereophonic listening mechanism, 44th Audio Engineering society convention, February 1973 (hereinafter “Bernfeld”). On transient sounds, if there is a delay difference between the transients in the two channels, then inter-channel delay and HAAS effect are also involved in the perceived phantom direction, as is described in greater detail in Gardner M. B, Historical background of the Haas and or precedence effect, J. of Acoustical Society of America, No. 43, 1968 (hereinafter “Gardner M. B”).

In conventional stereo, stereophonic ‘width matrix’ is a method for enhancing a conventional stereo image, by applying a 2×2 matrix of gains, two of which are negative, at each audio sample, to the vector [Lj, Rj] formed by the samples of the two channels. The result is a wider stereo image in which phantom images move away from the center, as is described in greater detail in Bauer B, “Some techniques towards better stereophonic perspective”, Journal of the Audio Engineering Society, August 1969 (hereinafter “Bauer”). This method alone, however, is not adequate to stereo reproduction of closely spaced loudspeakers, since it is not capable of causing phantom images to move outside of the angular range between the loudspeakers.

Many alternative two-loudspeakers audio reproduction methods have been proposed in attempt to overcome a substantial limitation of conventional stereo, namely, the restriction of the direction of the phantom images to the space between the two loudspeakers. In accordance with some proposed methods, it is enough to post-process the signals at the reproduction stage (such as in the case of head-related transfer functions (HRTF) oriented methods, as described in greater detail in Gardner W. G., 3-D Audio Using Loudspeakers, Kluer Academic publishers 1998, pp 24-59, 77-78 (hereinafter “Gardner W. G”)), while in accordance with other methods (such as cross-talk cancellation), the recorded signal itself also needs to be different than conventional stereo (like binaural recordings, as is described in greater detail in Begault D. R., 3-D sound for virtual reality and multimedia, AP professional 1994, pp 119-122, 220-225 (“hereinafter Begault”)). Many of those methods are commonly referred to by such popular titles as ‘3D Audio’ or ‘Virtualization’.

Some of the methods which have been proposed in attempt to enhance perceived stereo sound beyond the space between the two, include the use of a processing stage commonly referred to as ‘cross-talk cancellation’ which is intended to prevent unwanted information from the left loudspeaker from reaching the right ear of the listener, and vise versa. One technique which is used to achieve “cross-talk cancellation” includes sending a phase inverted acoustic signal that cancels the cross-talk between each opposite loudspeaker and ear, as is illustrated in FIG. 1A. This kind of processing is intended to allow the ears of a listener to perceive sound directions in a manner which is less dependent upon the directions of the loudspeakers themselves. In order to achieve such effects, some aspects of the HRTF need to be taken into account, including aspects associated with the Ipsilateral transfer function which is associated with the relation between the sound source and the close ear, and the Contralateral transfer function which is associated with the relation between the sound source and the opposite ear.

However, when the loudspeakers are substantially closely spaced the acoustic cross-talk signal between each opposite loudspeaker and ear is hardly obscured by the head, as is illustrated in FIG. 1B, and as a result, HRTF based techniques are not required. For closely spaced loudspeakers, a specific kind of cross-talk cancellation method, called ‘dipole processing’, is commonly applied, as is discussed in greater detail in Kirkeby O., Nelson P. A., The stereo dipole—a virtual source imaging system using two closely spaced loudspeakers, J. Audio Engineering Society, Vol 46, No. 5 1998 (hereinafter “Kirkeby”). Essentially, in ‘dipole processing’ as in substantially all cross-talk cancellation methods, the cross-talk canceling signal is generated from a delayed, possibly filtered, and phase inverted channel audio data, added to the opposite channel of the stereo. The purpose of the delay is to compensate for the path difference of the sound traveling to the opposite ear. The delays can be implemented digitally or through a network of all-pass filters.

When cross-talk cancellation methods and/or HRTF methods are applied, the result is usually unsatisfactory. The shortcomings of cross-talk cancellation methods and/or HRTF methods become apparent when we consider that in order to cause the auditory system into interpreting the phantom direction as coming from outside the angular range between the loudspeakers, the cross-talk cancellation filter or HRTF filter must factor-in the specific head shape and ears of the listener. If a person listens through the filters matched to another person, the results are fatiguing to listen to, and may bring about a total collapse of the stereo image. In addition, cross-talk cancellation methods are very sensitive to the position of the listener's head and its orientation, and a slight head displacement may cause the delayed signal of the cancellation component to generate (acoustically) an unpleasant comb-filter. The dipole method, however, is less sensitive to a specific listener, as it does not take the head diffraction filter into account.

Another shortcoming of current cross-talk cancellation systems is manifested when conventional stereo signals are fed to loudspeaker cross-talk cancellation systems. Such stereo signals frequently contain synthetically mixed monophonic sound components, which are identical in both channels. On such input sound components, the processed and reproduced sound is still monophonic (equal acoustic signal from the two loudspeakers), thus no stereo effect is produced. Moreover, the mono components are still subject to a comb-filter caused by the cross delayed signals, resulting in an unpleasant frequency response. Various aspects of this comb-filter are described in U.S. Pat. No. 5,440,638 to Lowe, et al.; and U.S. Pat. No. 6,219,426 to Daniels, et al., all attempting to remove common (mono) sound component(s) of the two channels. However, removing the common component(s) from the original stereo signal results not only in removing center direction sound sources, but distorts the directionality of a part of the energy of sound sources from half-left or from half-right directions. Consider for example, a single sound source artificially panned to some stereo position between center and the left loudspeaker, and suppose that the stereo channel signals are Left(t)=A(t) and Right(t)=0.5*A(t) for some signal A(t). Then the part that is uncommon between the channels is the difference signal S(t)=Left(t)−Right(t)=0.5*A(t) and only this part is cross-talk cancelled. However the omni-directional signal part M(t)=Left(t)+Right(t)=1.5*A(t) is not processed, although when radiated from two loudspeakers this omni directional part does generate cross-talk between the listeners ears. The result is some disintegration of the phantom directions around half-way left and half way right.

Another disadvantage of current cross-talk cancellation systems is that if mono inputs (like some old recordings) are fed to those center-removing systems, no effect is perceived whatsoever.

Yet a further shortcoming of current cross-talk cancellation techniques is the large gain factors of the cross-talk cancellation filters, mainly in the low frequency range, which conflict with the practically limited dynamic range of audio distribution and reproduction systems. These gain factors are caused by the need to generate, for each loudspeaker audio feed, the cross-talk canceling term at opposite loudspeaker in order to achieve an acoustic cancellation. Each of the cross-talk cancellation filters is likely to boost low frequencies by an order of 30 dB or more.

Yet another problem of some cross-talk cancellation methods is the incoherence of phase at high frequencies due to non-linear loudspeaker response and due to small head movements of the listener. Yet another problem of some cross-talk cancellation methods is the relatively small ‘sweet-spot’, i.e. the best area for listening. As can be appreciated, the frequency range for this type of effect becomes rather limited.

Generally, in the special case of the two loudspeakers being closely spaced, the dipole processing (dipole filter) is preferred, as is detailed in Kirkeby: In a typical situation the loudspeakers are in front of the listener, and the listener is at equal distance from the two loudspeakers. The angle in which the listener sees the loudspeakers is called ‘span’, and is typically less than 20 degrees. The purpose of the dipole filter is to acoustically cancel out the radiation from each loudspeaker to the opposite ear. An example of a digital implementation of the dipole filter includes, initially filtering both of the channels digitally using a comb filter H(z) of transfer function:
H(z)=1/(1−Gc\hat{ }2*z\hat{ }(−2*TAOc))
Subsequently each channel signal is delayed by TAOc samples, attenuated by Gc, and subtracted from the un-delayed/un-attenuated opposite channel signal. The gain Gc and the delay TAOc are pre-computed from the speed of sound, the distance of listener and the span angle.

The use of both conventional cross-talk cancellation systems and dipole filters is reported to produce a wide stereo image beyond the angular range between the loudspeakers (as is described in Kirkeby and in Gardner W. G). This is true not just for binaural recordings but also for conventional stereo recordings. The reason for this can be demonstrated in the following example: suppose a 5 kHz tone signal is fed only to the left stereo input Lin=tone, Rin=0. This represents a phantom direction at the left loudspeaker. At the listeners ears after the dipole filter, only the left ear will hear Lout while the right ear's cross-talk of Lout will be cancelled acoustically. Thus the listener will only hear a 5 kHz tone sound coming from his fully-left which is well beyond the direction of the left original loudspeaker.

The dipole approach ameliorates some of the problematic properties indicated earlier: The cross-talk cancellation in this case is purely acoustic and does not depend on the head shape of a specific listener. The phase is less sensitive to head movements (as can be demonstrated geometrically), and the sweet-spot is larger (from the same reason). Still however, applying this method alone is not sufficient since only a limited band of frequencies can be processed this way as is described in Kirkeby. The low frequency range is limited by the necessary large gain factors at the processing stage, and the high frequency range is limited by the ‘ringing’ frequency of the comb-filter described above. The ringing frequency increases when the span angle is reduced, but in the same time the boost of low frequencies in the loudspeaker feeds are more sever.

Another method for enhancing stereo (or mono) audio reproduction includes simulating an acoustic space surrounding the sound-source. In mono or stereo, the simulation of the acoustic space surrounding the sound source is achieved by applying a special reverberation filter to the audio signal, which is intended to simulate reflections arriving from walls or objects in an imaginary room. The reflections are implemented as discrete FIR filter taps, as described in greater detail in Niimi K., Fujino T., Shimizu Y., A new digital reverberation with excellent control capability of early reflections, Audio Engineering Society 74th Convention, 1983 (hereinafter “Niimi, et al.”), and/or as IIR filters, as described in greater detail in Jot J. M., Chaigne A., Digital delay networks for designing artificial reverberators, Audio Engineering Society 90th convention, 1991 (hereinafter “Jot, at al”), in both cases, with very long impulse responses. The perception of space is guided by the relative delays between the direct sound and the reflections, and by the difference and de-correlation between the left channel reflections and the right channel reflections in stereo, as is described in greater detail in Blaubert J., Spatial hearing, MIT press 1997, p. 282, pp 348-358 (hereinafter “Blaubert”). The perceived distance to the source is determined mainly by the relative gains and delays of the direct sound and of the reflections as is described in greater detail in U.S. Pat. No. 5,555,306 to Gerzon. When applying such a reverberation filter on a stereo input, then summing it in some relative level to the input (simulating the direct sound path), the results tend to sound wider and more spacious than the original. It has been discovered that a sufficient number of early-reflections from side directions are needed to obtain a desirable spatial impression, as is described in Blaubert, which closely spaced loudspeakers cannot provide in conventional stereo.

However, in the context of widening the stereo image, it is expected by the human auditory system and brain that reflections of a real room arrive from many different directions surrounding the listener (as would be natural for a person in a room), and since in a conventional reverberation filter the direction of each individual reflection is reproduced as conventional stereo, this method is not capable of generating reflection directions beyond the angular range between the loudspeakers. Moreover, if the stereo image is narrow (as with closely spaced loudspeakers), the reflections arrive from an angle close to the angle of the direct sound, resulting in undesired masking of the enhanced input sound, as well as in undesired comb-filter effects, as is described in greater detail in Moorer J. A, About this reverberation business, Computer Music (hereinafter: “Moorer et al.”).

The use of a reverberation filter, such as a reverb, through a cross-talk cancellation system, has been discussed in prior art, for example in Gardner W. G and in Begault. However, in all cases the reverberation filter is added to the direct signal before the direct signal is applied to the cross-talk cancellation system, or in parallel to applying the cross-talk cancellation to the direct signal. As a consequence the complete stereo produced in this manner is also unsatisfactory and suffers from many or all of the problems discussed above.

There is thus a need in the art for a system, method and circuit for widening the stereo-image in stereo reproduction using loudspeakers. There is a further need in the art for a system, method and circuit for widening the stereo-image produced by two or more closely spaced loudspeakers. There is yet a further need in the art for a system, method and circuit for widening the stereo-image produced by two or more closely spaced loudspeakers, while maintaining a substantially robust and accurate acoustic simulation of an acoustic space surrounding the loudspeakers.

### SUMMARY OF THE INVENTION

Some embodiments of the present invention relate to a method and a circuit for processing an audio signal. In accordance with some embodiments of the present invention, there is provided an audio processing circuit including a first signal path, a second signal path and an output adder. The first signal path may be configured to allow an input signal to pass through the audio processing circuit substantially unaffected. The second signal path may include a reverberation filter and a cross-talk cancellation filter adapted to receive an output of the reverberation filter directly or indirectly. The audio processing circuit may further include an output adder, and the output adder may be adapted to receive and combine the output of the direct signal path and the output of the second signal path.

In accordance with further embodiments of the present invention, each of the first the second signal paths may be adapted to receive an audio signal including two channels, and each of the first and second signal paths may be adapted to output an audio signal including two channels.

In accordance with further embodiments of the present invention there is provided an audio processing circuit including a direct signal path, an effect path and an output adder. In accordance with some embodiments of the present invention, the direct signal path may be configured to allow an input signal to pass through the audio processing circuit substantially unaffected. The effect path may include at least a reverberation filter and a cross-talk cancellation filter. In accordance with some embodiments of the present invention, the cross-talk cancellation filter may be adapted to receive an output of said reverberation filter directly or indirectly. The output adder may be adapted to receive and combine the output of the direct signal path and the output of the effect path.

In accordance with further embodiments of the present invention, each of the direct signal path and the effect signal path may be adapted to receive an audio signal including two channels, and each of the direct signal path and the effect signal path may be adapted to output an audio signal including two channels.

In accordance with yet further embodiments of the present invention, there is provided a method of processing an audio signal. In accordance with some embodiments of the present invention, the method of processing an audio signal may include receiving an audio signal. The audio signal may be applied to a direct signal path giving rise to a direct signal. The audio signal may also be (e.g., in parallel) processed giving rise to delayed replicas of the audio signal. The delayed replicas of the audio signal may be filtered giving rise to an uncross-talked signal, and the uncross-talked signal may be combined with the direct signal.

In accordance with further embodiments of the present invention, the received audio signal may include two channels. In accordance with yet further embodiments of the present invention the direct signal and the uncross-talked signal may each include two channels.

Thus, according to certain embodiments of the present invention, it may be advantageous to apply a cross-talk cancellation filter only to a reverberation signal and not to a direct signal.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A is an illustration of an exemplary implementation of cross-talk cancellation filtering in audio processing circuits of the prior art;

FIG. 1B is an illustration of an exemplary implementation of dipole filtering in audio processing circuits of the prior art commonly used with substantially closely spaced speakers;

FIG. 2A is a block diagram illustration of an audio processing circuit, in accordance with some embodiments of the present invention;

FIG. 2B is a block diagram illustration of an audio processing circuit, in accordance with further embodiments of the present invention;

FIG. 3 is a block diagram illustration of an audio processing circuit in accordance with exemplary embodiments of the present invention;

FIG. 4 is an audio processing circuit wherein a direct signal path includes a width matrix module, in accordance with some embodiments of the present invention;

FIG. 5 is a block diagram illustration of a stereo widening circuit wherein a direct signal path includes a width matrix module, in accordance with further embodiments of the present invention.

FIG. 6 is an audio processing circuit in accordance with some embodiments of the present invention;

FIG. 7 is an audio processing circuit in accordance with further embodiments of the present invention;

FIG. 8 is an inside structure of an exemplary cross-talk cancellation filter, in accordance with some embodiments of the invention;

FIG. 9 is a block diagram illustration of an exemplary reverberation filter in accordance with further embodiments of the present invention; and

FIG. 10 is a block diagram illustration of an exemplary reverberation filter in accordance with further embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some embodiments of the present invention relate to a method and a circuit for processing an audio signal. In accordance with some embodiments of the present invention, there is provided an audio processing circuit including a first signal path, a second signal path and an output adder. The first signal path may be configured to allow an input signal to pass through the audio processing circuit substantially unaffected. The second signal path may include a reverberation filter and a cross-talk cancellation filter adapted to receive an output of the reverberation filter directly or indirectly. The audio processing circuit may further include an output adder, and the output adder may be adapted to receive and combine the output of the direct signal path and the output of the second signal path.

In accordance with further embodiments of the present invention, each of the first the second signal paths may be adapted to receive an audio signal including two channels, and each of the first and second signal paths may be adapted to output an audio signal including two channels.

In accordance with further embodiments of the present invention there is provided an audio processing circuit including a direct signal path, an effect path and an output adder. In accordance with some embodiments of the present invention, the direct signal path may be configured to allow an input signal to pass through the audio processing circuit substantially unaffected. The effect path may include at least a reverberation filter and a cross-talk cancellation filter. In accordance with some embodiments of the present invention, the cross-talk cancellation filter may be adapted to receive an output of said reverberation filter directly or indirectly. The output adder may be adapted to receive and combine the output of the direct signal path and the output of the effect path.

In accordance with further embodiments of the present invention, each of the direct signal path and the effect signal path may be adapted to receive an audio signal including two channels, and each of the direct signal path and the effect signal path may be adapted to output an audio signal including two channels.

In accordance with yet further embodiments of the present invention, there is provided a method of processing an audio signal. In accordance with some embodiments of the present invention, the method of processing an audio signal may include receiving an audio signal. The audio signal may be applied to a direct signal path giving rise to a direct signal. The audio signal may also be (e.g., in parallel) processed giving rise to delayed replicas of the audio signal. The delayed replicas of the audio signal may be filtered giving rise to an uncross-talked signal, and the uncross-talked signal may be combined with the direct signal.

In accordance with further embodiments of the present invention, the received audio signal may include two channels. In accordance with yet further embodiments of the present invention the direct signal and the uncross-talked signal may each include two channels.

In accordance with some embodiments of the present invention an effect path and a direct signal path may be provided, wherein the effect path may include a combination of a reverberation filter and a cross-talk cancellation filter. In accordance with some embodiments of the present invention, the combination of the reverberation filter and the cross-talk cancellation filter may be used to enhance the reproduction of a stereo audio signal which is intended to be fed into two substantially closely spaced loudspeakers, in order to widen the reproduced stereo image perceived by a listener, in a manner which is intended to minimize the artifacts which were common to prior art solutions and to maximize the widening of the stereo image beyond the angular range between the loudspeakers. The reverberation filter and the cross-talk cancellation filter may be in cascade and may be connected directly or indirectly to each other and to the other parts or components of the circuit or system. In accordance with one embodiment of the invention, the cross-talk cancellation filter may be a dipole filter.

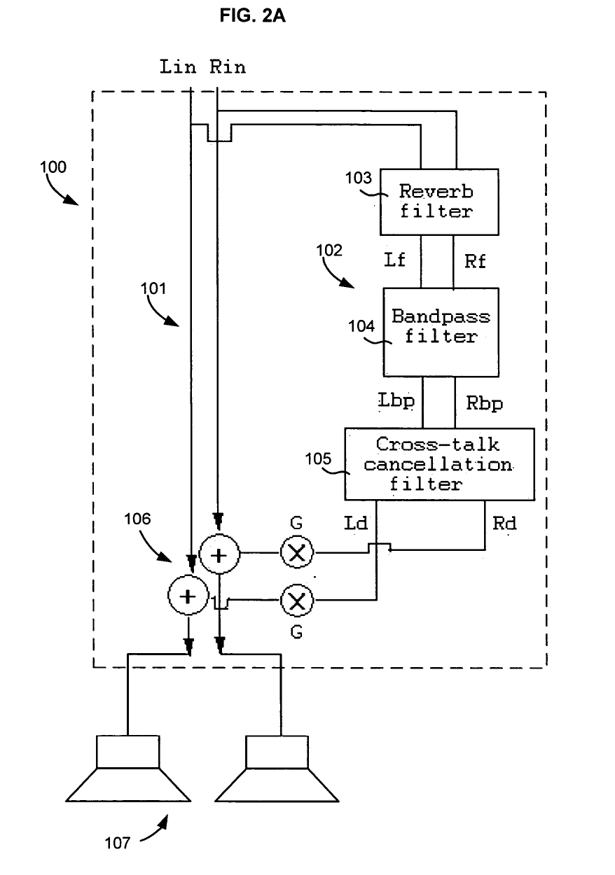

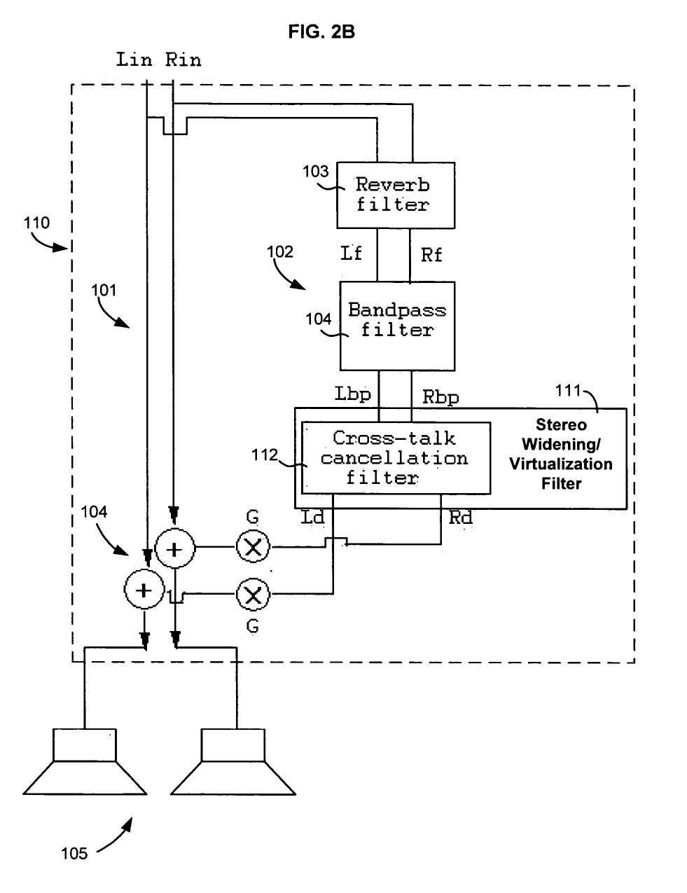

Reference is now made to FIG. 2A, which is a block diagram illustration of an audio processing circuit, in accordance with some embodiments of the present invention. In accordance with some embodiments of the present invention, the audio processing circuit 100 may include a first signal path 101 and a second signal path 102. In accordance with some embodiments of the present invention, the first signal path may be a direct signal path 101, and the second signal path may be an effect path 102. The effect path 102 may include at least a reverberation filter 103 and a cross-talk cancellation filter 105 operatively coupled in series to the reverberation filter 103, such that the cross-talk cancellation filter 105 receives the output of the reverberation filter 103. The audio processing circuit 100 may further include an output adder 106 adapted to receive the output of the direct signal path 101 and the output of the effect path 102 and combine (or mix) them. In accordance with some embodiments of the present invention, the output adder 106 may be operatively connected to the output-end of the direct signal path 101 and to the output end of the effect signal path 102.

In accordance with some embodiments of the present invention, the effect path 102 may further include a bandpass filter 104. The bandpass filter 104 may be connected to the output end of the reverberation filter 103 one the one hand, and to the input end of the cross-talk cancellation filter 105. Thus, in accordance with some embodiments of the present invention, the bandpass filter 104 may be adapted to allow only a certain frequency range of the reflection produced by the reverberation filter 103 to be input to the cross-talk cancellation filter 105. The advantages of using a bandpass filter as described above, shall be discussed in greater below.

As part of some embodiments of the present invention, the audio processing circuit 100 may be operatively connected to a sound reproduction device or system 107. In accordance with some embodiments of the present invention, the two channel output of the audio processing circuit 100 may be fed to the sound reproduction system 107 which may be adapted to generate acoustical signal (audio output) in accordance with the two channel output of the audio processing circuit 100.

In accordance with some embodiments of the present invention, the audio processing circuit 100 may be input with a stereo signal, for example, a standard stereo signal. In accordance with some embodiments of the present invention, once received at the audio processing circuit 100, the input stereo signal may be directed into or may be allowed to propagate through both the direct signal path 101 and the effect path 102. The signal passing through the effect path 102 may be processed and modified as will be discussed in greater detail below, while the signal passing through the direct signal path 101 may remain substantially unchanged. The substantially unmodified output of the direct signal path 101 and the processed signal output of the effect path 102 may be input to the output adder 106 which may combine the output of the direct signal path 101 and the output of the effect path 102.

As mentioned above, the effect path 102 may include at least a reverberation filter 103 and a cross-talk cancellation filter 105. In accordance with some embodiments of the present invention, the reverberation filter 103 may be adapted to receive the input stereophonic signal and to generate delayed replicas of the original stereophonic signal. The delayed replicas generated by a reverberation filter 103 are also commonly referred to in the art as “reflections”, and accordingly, throughout the specification and the claims the terms “delayed replicas generated by a reverberation filter” and “reflections” may be interchangeably used.

In accordance with further embodiments of the present invention, the reverberation filter 103 may be configured to generate the delayed replicas of the original stereophonic signal in a manner to create an acoustical illusion of ambience. Various kinds of reverberation filters are known in the art. Reverberation filters are commonly used to generate an acoustical illusion of ambience by generating delayed replicas of the original sound which substantially mimic reflections of the original sound from walls (or other objects) in an imaginary room. Each of the reflections generated by the reverberation filter is essentially a delayed, attenuated, possibly filtered and possibly stereo-panned replica of the original stereophonic signal. The effect of the reverberation filter may be generally viewed as a simplified acoustic model of the behavior of a stereo signal when reproduced in a real room by two sound sources positioned within the room as it is perceived by a listeners' ears represented as two receptors also positioned within the room.

Reverberation filters are multi-channel filters, having at-least two channels, and may be applied to a mono or stereo source. It should be noted, that in accordance with some embodiments of the present invention, any suitable presently known or yet to be devised in the future reverberation filter may be implemented as part of the effect path, including but not limited to a digital reverberation filter, an analogue reverberation filter, a recursive reverberation filter, a convolution reverberation filter, a non-linear reverberation filter, or other variations as described in Jot J. M., Chaigne A., Digital delay networks for designing artificial reverberators, Audio Engineering Society 90th convention, 1991 (hereinafter: “Jot et al.”); Niimi K., Fujino T., Shimizu Y., A new digital reverberation with excellent control capability of early reflections, Audio Engineering Society 74th Convention, 1983 (hereinafter: “Niimi et al.”); Blaubert J., Spatial hearing, MIT press 1997, p. 282, pp 348-358; Blaubert J., Spatial hearing, MIT press 1997, p. 282, pp 348-358 (hereinafter: “Blaubert et al.”); and Moorer J. A, About this reverberation business, Computer Music (hereinafter: “Moorer et al.”), which are hereby incorporated by reference.

As mentioned above, and as is shown in FIG. 2A, the reflections generated by the reverberation filter 103 are fed into a cross-talk cancellation filter 105. In accordance with some embodiments of the present invention, the cross-talk cancellation filter 105 may be adapted to calculate an acoustic signal which is intended to cancel out the cross-talk between the two stereophonic signal components received from the reverberation filter 103, and may be adapted to add these cross-talk canceling signals to the relevant stereophonic signal component.

In accordance with some embodiments of the present invention, and as can be seen in FIG. 2A, the cross-talk cancellation filter 105 is applied along the effect path 102 to the signal arriving from the reverberation filter 103. However, in accordance with the present invention, the direct stereo signal carried through the direct signal path 101 may be summed to the output without any cross-talk cancellation. Thus, while the reproduced simulated reflections are subject to cross-talk cancellation filtering, the reproduced direct signal stereo corresponding to the original stereo is not subject to the cross-talk cancellation effect. As a result, the reproduced simulated reflections may be perceived by a listener as coming from wider angles beyond the angular range between the loudspeakers used to reproduce the signal, while the phantom images produced by the reproduced direct signal stereo may be perceived by the listener as coming from the original phantom image directions of the input stereo signal.

Those of ordinary skill in the art may appreciate that by applying the cross-talk cancellation filter to the reflections generated by the reverberation filter but, at the same time, allowing the direct stereophonic signal to pass through the audio processing circuit substantially unchanged, and summing the direct stereophonic signal with the reflections which have undergone cross-talk cancellation filtering, a desired psychoacoustic effect may be achieved. Furthermore, the summed direct stereophonic signal and the reflections which have undergone cross-talk cancellation filtering may present desirable improvements over the prior-art and may obviate various acoustical inaccuracies which were thus far inherent to some audio enhancement techniques.

Furthermore, as the reverberation filter 105 my be designed to generate only delayed reflections, if the HAAS effect is considered, also known as the precedence effect, in accordance with which, after hearing a signal, the ears will suppress any subsequent signals (such as an echo or reverberation) for about 40 milliseconds, assuming that these later signals are quieter than the original signal, then phantom image directions of sound in the input audio signal may be retained in the output acoustic signal, as known in the art as “precendence (HAAS) effect”, see for example Bauer B, “Some techniques towards better stereophonic perspective”, Journal of the Audio Engineering Society, August 1969. In addition, in accordance with some embodiments of the present invention, the reverberation filter 105 may be designed so that it minimizes the cross-correlation between the filter output channels, such that perceived widening effect for the input signal is maximal, and the output is a wide stereo sound. For example, in accordance with some embodiments of the present invention, the reverberation filter 103 may be configured to enable certain individual reflections to arrive only from the left channel or only from the right channel, thereby enabling to minimizes the cross-correlation between the filter output channels.

It should be noted that in accordance with some embodiments of the present invention, a wide stereo output may be generated using the audio processing circuit 100 in accordance with some embodiments of the present invention, even if the input stereo is, in fact, a mono signal (for example, when the two input channels are identical). In accordance with further embodiments of the present invention, the use of a low correlation left vs. right reverberation filter may also contribute to a substantial reduction of the comb-filtering effect which is generally considered to be disturbing. Such comb-filtering effect is typically produced by prior-art system when the stereophonic input signal included monophonic sound components. In order to overcome the comb-filtering effect, prior-art systems relay on binaural recordings to provide stereo inputs that do not include monophonic sound components, however, as mentioned above, the audio processing circuit 100 in accordance with some embodiments of the present invention, does not require that such special recording techniques be used and is capable of producing enhanced or widened stereo images from, for example, a standard stereophonic signal.

In accordance with one embodiment of the present invention, the reverberation filter 103 may be, for example, a reverberation filter which may be adapted to create a sum of N delayed replicas of the left channel input Lin, each replica may be attenuated and/or filtered and then summed together to generate the left channel filter output Lf, and to create another sum of N delayed replicas of the right channel input Rin, each replica may be attenuated and/or filtered and then summed together to generate the right channel filter output Rf, where the N delayed replicas are different between the left and the right channel. Another possible reverberation filter 103 which may be used in the audio processing circuit in accordance with some embodiments of the present invention may be a sum of N delayed replicas of a linear combination of the two input channels, for example, Lin+Rin or Lin-Rin, each replica attenuated and/or filtered, then summed together to the generate the left channel filter output Lf, and a sum of another N delayed replicas of the same linear combination, each replica attenuated and/or filtered, then summed together to the generate the right channel filter output Rf, where the N delayed replicas are different between the left and the right channel outputs. Additional reverberation filters 103 which may be used in accordance with some embodiments of the audio processing circuit 100 of the present invention may include but are not limited to: a recursive reverberation filter, such as the in Jot et al. Niimi et al., Blaubert et al., Moorer et al.

In accordance with some embodiments of the present invention, the cross-talk cancellation filter 105 (which may be applied to the output of the reverberation filter 103) may be applied only to a limited frequency range of the output of the reverberation filter. In accordance with some embodiments of the present invention, the bottom (low) limit which may be implemented in the audio processing circuit as part of a frequency filter or a frequency filter array, e.g., bandpass filters 104, configured to prevent certain frequencies from reaching the cross-talk cancellation filter 105 may be determined in accordance with the maximum gain allowed at low frequencies, whereas the top (high) frequency limit which may be implemented in the audio processing circuit as part of a frequency filter or a frequency filter array, e.g. bandpass filters 104, configured to prevent certain frequencies from reaching the cross-talk cancellation filter 105 may be determined in accordance with the ringing frequency of the cross-talk cancellation filter used in the audio processing circuit. It should be appreciated that the ringing effect due to high frequency input is commonly typical to a situation whereby the loudspeakers 107 are substantially closely spaced and whereby the cross-talk cancellation filter 105 includes a dipole filter(s) (or is a dipole filter(s)). However, the top and/or bottom limits may be determined in accordance with other factors and when different filters are used, for example, when the loudspeakers 107 are substantially distant from one another, it may be necessary to account for the internal transfer function (ITF), and when determining the top frequency limit the invariability of the ITF filter may be taken into consideration. In accordance with one exemplary embodiment of the present invention, the frequency range which may be applied to the cross-talk cancellation filter 105 may vary from a few hundred Hertz to a few thousands Hertz, and may be controlled using suitable filters. However, it should be noted that the present invention is not limited in this respect.

Furthermore, those of ordinary skill in the art may appreciate that when a dipole filter is applied to a direct sound source, the band limiting can be a strong limitation, as a result of which, the widening effect may be distorted, as frequencies from within the limited band subjected to the dipole processing may appear to come from different directions than frequencies outside of this band. However, when applying the cross-talk cancellation filter only to an output of a reverberation filter 103, as may be the case in the audio processing circuit 100 in accordance with some embodiments of the present invention, the problem may be substantially reduced. As is discussed in greater detail in Blaubert et al. which was incorporated by reference into the present application, the reverberation filters 103 can be low-passed to avoid the ringing frequency and the band above it, since the acoustic responses of real rooms present damping filters in the walls and air absorption, and therefore strong attenuation of high frequencies in the output of the reverberation filter 103 is natural and will not cause degradation of the acoustic simulation. In fact, it has been previously shown that most spatial impression is related to frequencies below 1500 Hertz or so (Blaubert et al.). In addition, the extreme low frequencies the cross-talk cancellation filter 105 may be unable to process (or to process successfully), can still be subject to the reverberation filter 103. The low frequency part of a wall reflection may not be stereo-widened by the cross-talk cancellation filter 105, so it will appear to come from a different direction than the frequency band that is subject to the cross-talk cancellation filter 105, but this also is an acceptable effect in this case, as directional hearing is very limited for high frequencies, as is discussed in Blaubert et al., and also for very low frequencies (80 Hz or so and below) the human hearing is not directional, thus the different direction may commonly not be perceived at these frequency range.

In accordance with some embodiments of the present invention, a conventional stereo width 2×2 matrix may be included as part of the first signal path 101 (also referred to herein in some places as the direct signal path) of the audio processing circuit 100. The inclusion of the stereo width matrix as part of the first signal path 101 may contribute to an even wider stereo image in the reproduced audio. Those of ordinary skill in the art may appreciate that for some stereo inputs, for example narrow stereo input (close to mono but not mono), the inclusion of the stereo width matrix as part of the direct signal path may contribute to the widening of the stereo image of the direct signal and may not affect the output signal of the effect path 102.

Turning now to FIG. 2B, there is shown a block diagram illustration of an audio processing circuit, in accordance with further embodiments of the present invention. In accordance with some embodiments of the present invention, as part of the effect path 102 of the audio processing circuit 110, the reverberation filter 103 may be connected to a stereo widening/virtualization filter 111. In accordance with some embodiments of the present invention, the stereo widening/virtualization filter 111 may be adapted to widen the stereo image of the reflection produced by the reverberation filter. In accordance with further embodiments of the present invention, stereo widening/virtualization filter 111 may include a cross-talk cancellation filter 112, which may be adapted to cancel cross-talk between the two (or more) output channels of the reverberation filter 103, as discussed above in greater detail.

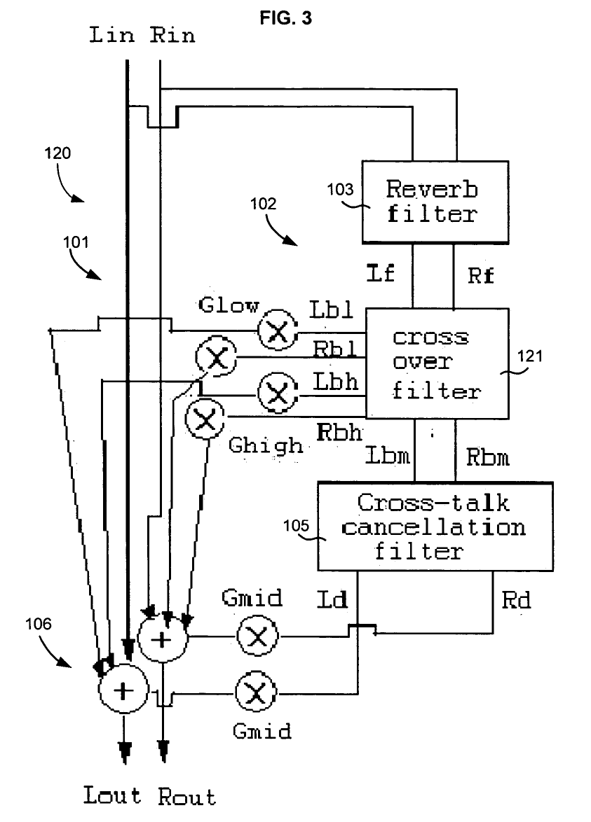

Reference is now made to FIG. 3, which is a block diagram illustration of an audio processing circuit in accordance with exemplary embodiments of the present invention. In accordance with some embodiments of the present invention, the input stereo (two-channel) signal [Lᵢₙ, Rᵢₙ] may be fed into an output adder 106 and into a reverberation filter 103. The stereo signal [L_{f}, R_{f}] from the output of the reverberation filter 103 may be fed into a crossover network 121 adapted to split the signal into, for example, three completing frequency bands. The stereo signal [L_{bm}, R_{bm}] from the output of middle band of the crossover network 121 may be fed into a cross-talk cancellation filter 105. The stereo signal [Ld, Rd] from the output of the cross-talk cancellation filter 105 may be amplified/attenuated with gain Gmid and then fed to the output adder 106. The stereo signal [Lbl, Rbl] from the output of lowest band of said crossover network 121 may be amplified/attenuated with gain Glow and then fed to said output adder 106. The stereo signal [Lbh, Rbh] from the output of highest band of the crossover network 121 may be amplified/attenuated with gain Ghigh and may then be fed into said output adder 106. The stereo signal [Lout, Rout] from the output of the output adder 106 may be fed to the final output.

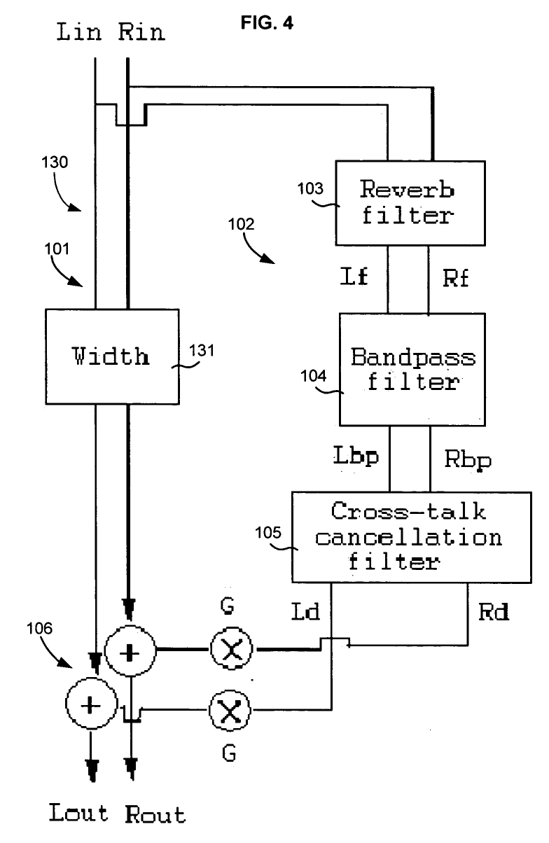

Turning now to FIG. 4, there is shown an audio processing circuit wherein a direct signal path includes a width matrix module, in accordance with some embodiments of the present invention. In accordance with some embodiments of the present invention, the direct signal path 101 may include a width matrix module 131. Accordingly, in accordance with some embodiments of the present invention, the input stereo (two-channel) signal [Lin, Rin] may be fed into a width matrix module 131 and into a reverberation filter 103. The stereo signal [Lf, Rf] from the output of said reverberation filter 131 may be fed into a band-pass filter 104. The stereo signal [Lbp, Rbp] from the output of the band-pass filter 104 may be fed into a cross-talk cancellation filter 105. The stereo signal [Ld, Rd] from the output of said cross-talk cancellation filter 105 may be amplified/attenuated by gain G and then fed into an output adder 106. The stereo signal [Lw, Rw] from the output of the width matrix module 131 may also be fed into said output adder 106. The stereo signal [Lout, Rout] from the output of said output adder 106 may be fed to the final output.

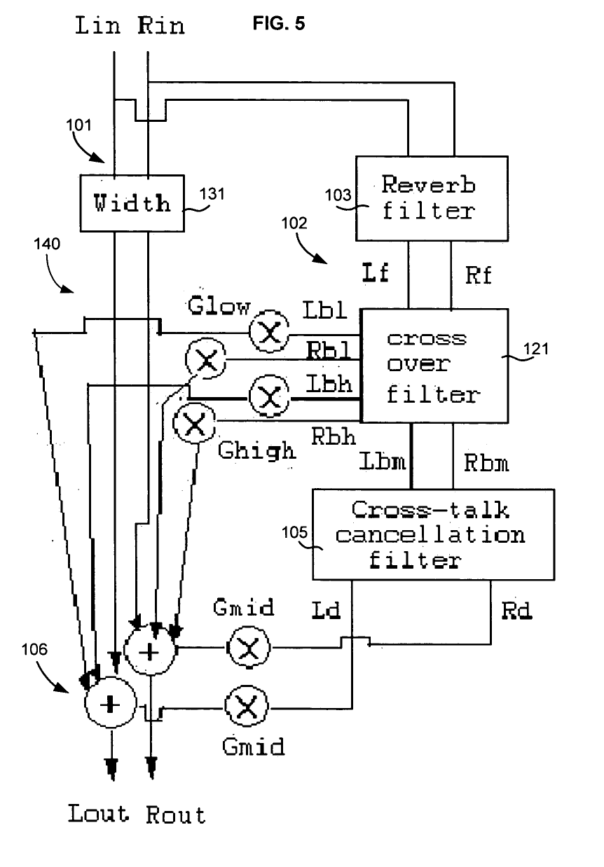

Reference is now made to FIG. 5, which is a block diagram illustration of a audio processing circuit wherein a direct signal path includes a width matrix module, in accordance with further embodiments of the present invention. In accordance with some embodiments of the present invention, the input stereo (two-channel) signal [Lin, Rin] may be fed into a width matrix module 131 over a first signal path 101 and into a reverberation filter 103 over a second signal path 102. The stereo signal [Lf, Rf] from the output of the reverberation filter 103 may be fed into a crossover network 121, splitting the signal into three, for example, completing frequency bands. The stereo signal [Lbm, Rbm] from the output of middle band of the crossover network 121 may be fed into a cross-talk cancellation filter 105. The stereo signal [Ld, Rd] from the output of the cross-talk cancellation filter 105 may be amplified/attenuated with gain Gmid and then fed to an output adder 106. The stereo signal [Lbl, Rbl] from the output of the lowest band of the crossover network 121 may be amplified/attenuated with gain Glow and then fed to the output adder 106. The stereo signal [Lbh, Rbh] from the output of highest band of the crossover network may be amplified/attenuated with gain Ghigh and may then be fed into said output adder 106. The stereo signal [Lw, Rw] from the output of the width matrix module 131 may be fed into the output adder 106. The stereo signal [Lout, Rout] from the output of the output adder 106 may be fed to the final output.

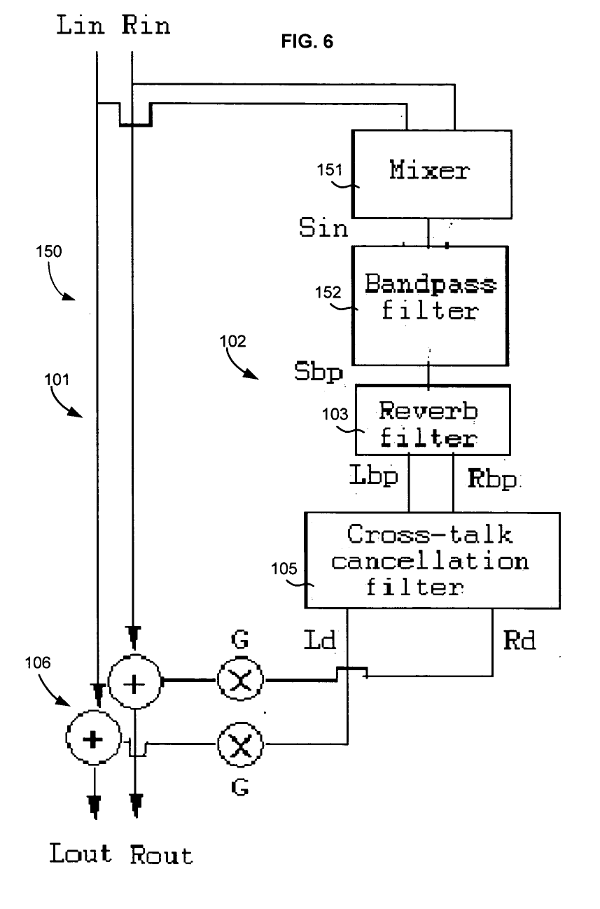

Turning now to FIG. 6, there is shown an audio processing circuit in accordance with some embodiments of the present invention. In accordance with some embodiments of the present invention In a fifth embodiment of the invention, the effect path 102 of the audio processing circuit 150 may include a mixer 151 and a bandpass filter 152 connected in series to the mixer. The output end of the bandpass filter may be connected to the reverberation filter 103, the output end of the reverberation filter 103 may be connected to the cross-talk cancellation filter 105, and the output end of the cross-talk cancellation filter 105 may be connected to the output adder 106.

In accordance with some embodiments of the present invention, the input stereo (two-channel) signal [Lin, Rin] may be fed into the output adder 106 and into an input mixer 151. The input mixer 151 may be adapted to compute a mono linear combination of its inputs Sin=a*Lin+b*Rin. The mono signal Sin from the input mixer 151 may be fed into a band-pass filter 152, the mono signal output of the band-pass filter 152 may be fed into a reverberation filter 103 (mono to stereo). The stereo signal [Lf, Rf] from the output of the reverberation filter 103 may be fed into a cross-talk cancellation filter 105. The stereo signal [Ld, Rd] from the output of the cross-talk cancellation filter 105 may be amplified/attenuated by gain G and then fed into said output adder 106. The stereo signal [Lout, Rout] from the output of said output adder 106 is fed to the final output.

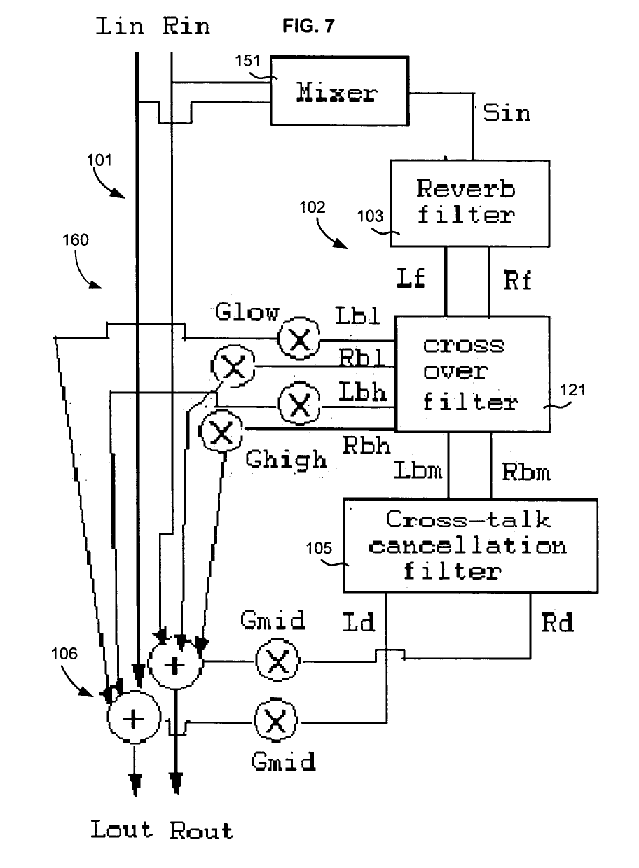

Reference is now made to FIG. 7, which is an audio processing circuit in accordance with further embodiments of the present invention. In accordance with some embodiments of the present invention, the input stereo (two-channel) signal [Lin, Rin] received at the audio processing circuit 160 may be fed into an output adder 106 and into an input mixer 151. The input mixer 151 may be adapted to compute a mono linear combination of its inputs Sin=a*Lin+b*Rin. The mono signal Sin from the input mixer 151 may be fed into a reverberation filter 103. The stereo signal [Lf, Rf] from the output of the reverberation filter 103 may be fed into a crossover network 121, splitting the signal into three, for example, completing frequency bands. The stereo signal [Lbm, Rbm] from the output of middle band of the crossover network 121 may be fed into a cross-talk cancellation filter 105. The stereo signal [Ld, Rd] from the output of said cross-talk cancellation filter 105 may be amplified/attenuated with gain Gmid and then fed to said output adder 106. The stereo signal [Lbl, Rbl] from the output of lowest band of the crossover network 121 is amplified/attenuated with gain Glow and then fed to the output adder 106. The stereo signal [Lbh, Rbh] from the output of highest band of the crossover network 121 may be amplified/attenuated with gain Ghigh and may then be fed into the output adder 106. The stereo signal [Lout, Rout] from the output of the output adder 106 may be fed to the final output.

It should be note that the present invention is not bound by the specific configurations described with reference to FIGS. 2-7, and accordingly various modifications may be applied. Thus in accordance with one embodiment, certain pre-processing may be applied to the input stereo signal and/or to the input signal of the reverberation filter. By way of another embodiment certain post-processing may be applied to the audio signal before being summed to the output adder. By way of still another non-limiting example, various equalization filters may be implemented and positioned anywhere in the processing chain. By way of still another non-limiting example, the order of the reverberation filter, the cross-talk cancellation filter, and the low-pass and/or band-pass filters may be interchanged (the results may not necessarily be identical but in some particular the overall effect may be preserved to some degree). By way of still another non-limiting example, the cross-talk cancellation filter may be a part of a larger filter module, comprising a cross-talk cancellation filter and yet other filters such as HRTF filters, for example.

It should also be noted that in some of the embodiments of the present invention discussed above the band-pass filter is in the general sense, and that further embodiments of the present invention may include more specific kinds of bandpass filters, such as a low-pass filter, for example.

Note also that various embodiments of the present invention which were discussed above may be adjusted in a variety of ways, for example, by relocating the bandpass filter and positioning the bandpass filter to before the reverberation filter or to after the cross-talk cancellation filter, etc. The invention is not limited to the use of any particular number or kind of bandpass filter(s) and/or to a specific positioning of the bandpass filter(s). Also, said band-pass filter may be a part of said reverberation filter or a part of said cross-talk cancellation filter.

Additionally it should be noted that in accordance with some embodiments of the present invention, a width matrix may be connected indirectly to the direct signal path or to the output adder, or may be replaced with an equivalent stereo widening module.

Those versed in the art will readily appreciate that other modifications may be applied, depending upon the particular application.

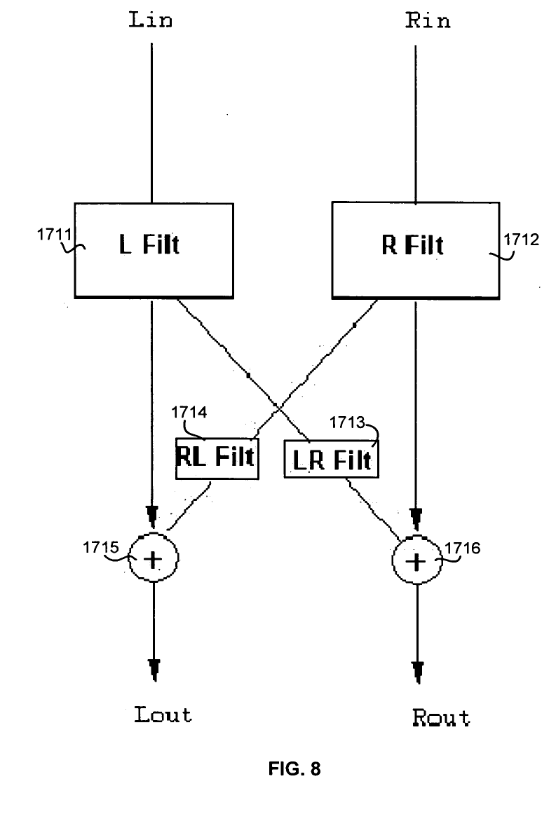

Turning now to FIG. 8, there is shown an inside structure of an exemplary cross-talk cancellation filter, in accordance with some embodiments of the invention. In accordance with some embodiments of the present invention, the left input signal may be fed into a left filter 1711, and the right input signal is fed into a right filter 1712, the output signal of the left filter 1711 may be fed into a left adder 1715, and also fed into a left-to-right filter 1713. The output signal of the right filter 1712 may be fed into a right adder 1716, and also fed into a right-to-left filter 1714. The output of said left-to-right filter 1713 may be sign inversed and may be fed into said right adder 1716, and the output of the right-to-left filter 1714 may be sign inversed and may be fed into said left adder 1715. The output of the left adder 1715 and the output of the right adder 1716 may be fed to a stereo output. Since the system is essentially linear, then said left filter 1711 and said right filter 1712 may be applied in the output of the left and right adders 1715 and 1716 instead.

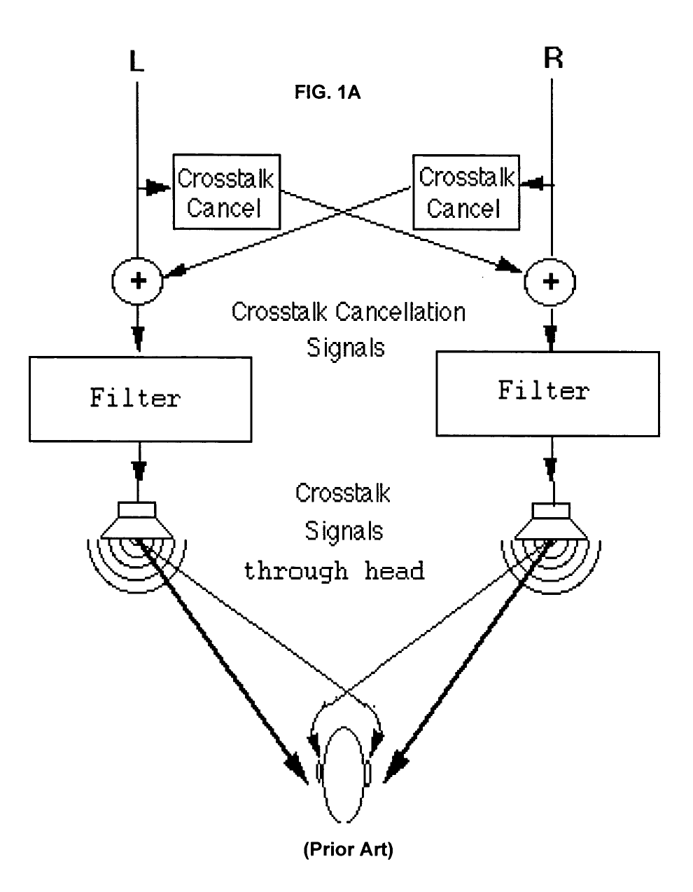

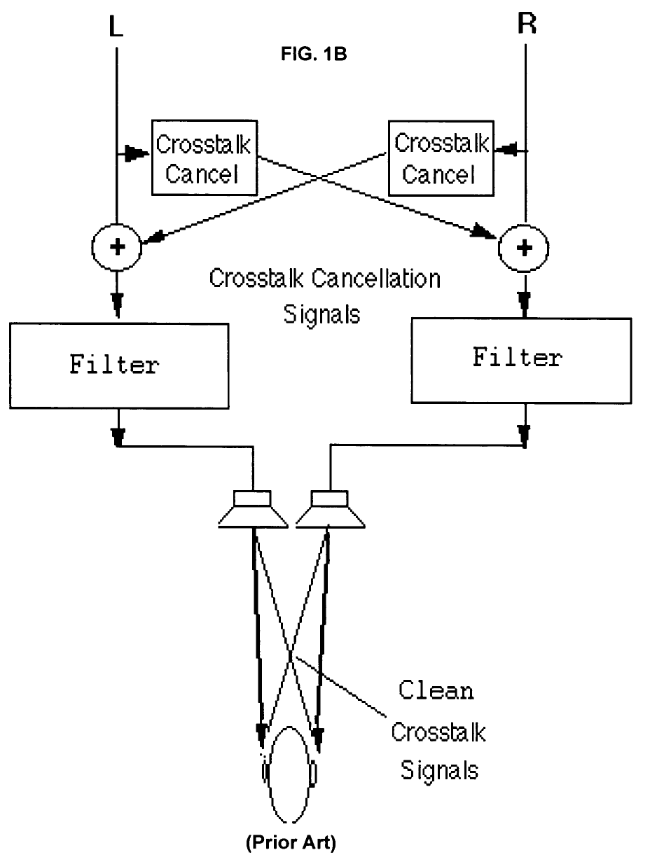

As can be seen in the prior art FIG. 1A, the direct filters can also be located after the adders. Thus in FIG. 8, the filters 1711 and 1712 may be moved to the output of the adders 1715 and 1716, by modifying the right-to-left filter 1714 and left-to-right filter 1715.

In accordance with one embodiment of the present invention, for example, when the cross-talk cancellation filter included in the audio processing circuit is specifically suitable for the case of two loudspeakers not closely spaced, the left-to-right filter and the right-to-left filters may be associated with functions of an estimation of the Interaural transfer function (ITF), and the left filter and the right filter may be functions of estimations of both the ITF and the contralateral transfer function.

In a non-limiting possible implementation of said cross-talk cancellation filter, the implementation uses digital filters, having input interfaces to convert analog input signal to digital sampled signal, and with output interfaces to convert digital filtered signal to analog output signal (if the input or output are digital, the interfaces can be avoided). Also, the left filter and the t filter may be identical filters, each including a cascade of comb filter and equalization filter, where the comb filters may be given by H1(z)=1/(1−Hitf\hat{ }2), for example, the equalization filters may be given by H2(z)=1/Hi(z), for example, and the left-to-right filter may be identical to the right-to-left filter and may be given by H3(z)=Hitf(z), for example, wherein Hi is an estimation of the Ipsilateral transfer function translated to digital domain, and Hitf is an estimation of the interaural transfer function translated to digital domain.

In accordance with one embodiment of the present invention, for example, when the cross-talk cancellation filter for the case of two loudspeakers closely spaced, a diople filter may be used. In case a dipole filter case is used, the left-to-right filter and the right-to-left filter and the left filter and the right filter may all be functions of an estimation of the distance between the two ears and of the position of the loudspeakers.

In accordance with a non-limiting possible implementation of the dipole filter, the implementation uses digital filters, having input interfaces adapted to convert analog input signal to digital sampled signal, and with output interfaces adapted to convert digital filtered signal to analog output signal (if the input or output are digital, the interfaces can be avoided). Also, the left filter and the right filter may be identical comb filters, and may be given by H1(z)=1/(1−Gc\hat{ }2*z\hat{ }(−2*TAOc)), for example, where Gc is a gain and TAOc is a delay, and the left-to-right filter may be identical to the right-to-left filter and may be given by H2(z)=−Gc*Z\hat{ }(−TAOc).

In accordance with an additional non-limiting possible implementation of some embodiments of the audio processing circuit of the present invention, the gains associated with the cross-over network filter Glow, Gmid, and Ghigh may be substantially equal. In accordance with another non-limiting example, the gains Glow and Ghigh may be substantially equal and the gain Gmid may be set to control the amount of the widening effect. Yet in accordance with another non-limiting example, said gains Glow and Gmid may be substantially equal and the gain Ghigh may be set to attenuate the high frequencies of the simulated reflections from the reverberation filter.

In accordance with an additional non-limiting possible implementation of some embodiments of the audio processing circuit of the present invention, the bandpass filter and/or the crossover network filter cutoffs may be selected as follows: The lower cutoff point between the lowest band and the middle band may be set in accordance with the maximum dipole filter gain allowed at low frequencies; The upper cutoff between the middle band and the highest band may be set in accordance with to the ringing frequency of a dipole filter. In another non-limiting example, the upper cutoff may be selected to substantially match a damping cutoff frequency for the wall-reflections of an imaginary room. In accordance with non-limiting example, the crossover filter network may be implemented as is described in Linkwitz S., “Active Crossover Filters for Noncoincident Drivers”, J. Audio Eng Soc., Vol 24, 1976 (hereinafter “Linkwitz”), which is hereby incorporated by reference into the present application.

In accordance with an additional non-limiting possible implementation of some embodiments of the audio processing circuit of the present invention, the input mixer may be implemented with a linear combination which may be set to a=0.5 and b=0.5. In accordance with another non-limiting example, the input mixer may be implemented with a linear combination which may be set to a=1 and b=−1.

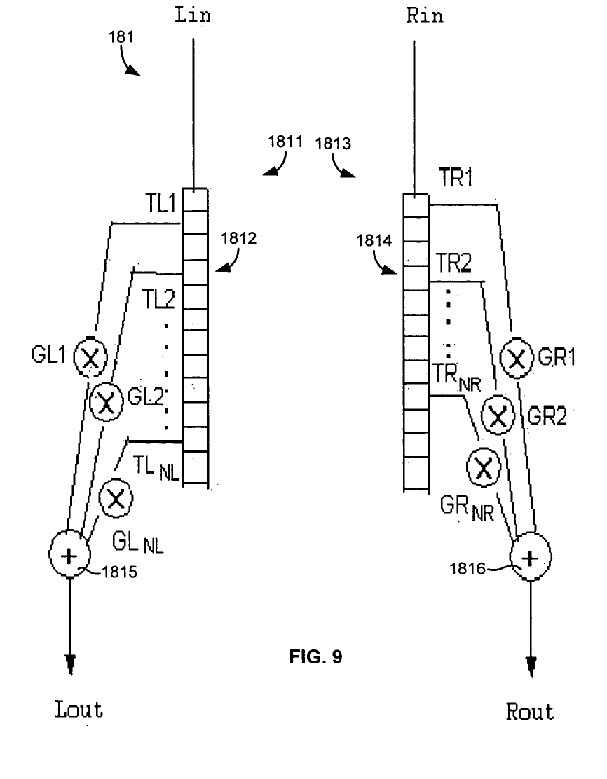

Reference is now made to FIG. 9, which is a block diagram illustration of an exemplary reverberation filter in accordance with further embodiments of the present invention. In accordance with some embodiments of the present invention, a non-limiting possible implementation of the reverberation filter may be a stereo-to-stereo filter 181 as is shown in FIG. 9. The stereo-to-stereo reverberation filter may be implemented as follows: the input signal Lin is fed into a left delay-line of M audio samples 1811. The left delay-line 1811 may be read at NL different delay taps TLi for a left channel 1812, NL<M. The input signal Rin may be fed into a right delay-line of M audio samples 1813. The right delay-line 1813 may be read at NR different delay taps TRj for a right channel, NR<M 1814, where NL may or may not be set equal to NR. At each tap i<NL, the value read at tap TLi is attenuated by a gain GLi and fed into a left adder 1815. At each tap j<NR, the value read at tap TRj may be attenuate by a gain GRj and may be fed into a right adder 1816. The output of the left adder 1815 is fed to the left channel output of the reverberation filter 181, and the output of the right adder 1816 is fed to the right channel output of the reverberation filter 181.

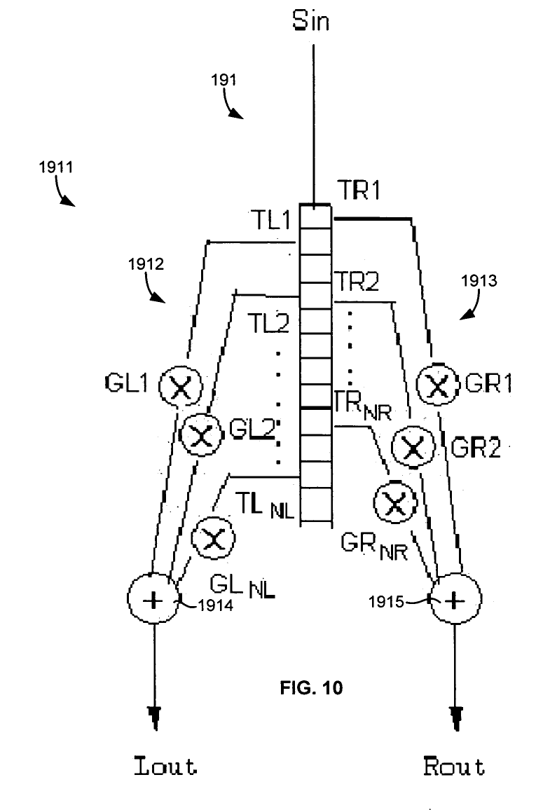

Reference is now made to FIG. 10, which is a block diagram illustration of an exemplary reverberation filter in accordance with further embodiments of the present invention. In accordance with some embodiments of the present invention, the reverberation filter 191 may be a mono-to-stereo filter. The mono-to-stereo reverberation filter 191 may be implemented as follows: The input signal Sin may be fed into a delay-line of M audio samples 1911. Said delay-line may be read at NL different delay taps TLi for a left channel 1912, NL<M, and at NR different delay taps TRj for a right channel 1913, NR<M, where NL may or may not be set equal to NR. At each tap i<NL, the value read at tap TLi may be attenuate by a gain GLi and fed into a left adder 1914. At each tap j<NR, the value read at tap TRj may be attenuate by a gain GRj and fed into a right adder 1915. The output of the left adder 1914 may be fed to the left channel output of the reverberation filter 191, and the output of the right adder 1915 may be fed to the right channel output of the reverberation filter 191.

In accordance with some embodiments of the present invention, in case the reverberation filter 191 is implemented digitally, and if the input and/or output to said reverberation filter are analog signals, then the reverberation filter 191 may include comprises interfaces or converters, for example A/D and/or D/A converters, for converting analog audio to digital audio at its input, and/or interfaces or converters, for example A/D and/or D/A converters, to convert digital audio to analog audio at its output.

In accordance with some embodiments of the present invention, the audio processing circuit may include a stereo-widening filter which may be implemented as part of the effect path. In accordance with some embodiments of the present invention the stereo-widening filter may include at least a cross-talk cancellation filter. In accordance with further embodiments of the present invention, the stereo widening filter may further include stereo widening circuitry and/or logic. As part of a non-limiting example of stereo widening filter which may be implemented in some audio processing circuit in accordance with some embodiments of the present invention, the stereo widening filter may be or may include but is not limited to one or more of the following: HRTF filters, and/or width matrixes, and/or digital delays, and/or all-pass filters.

It will also be understood that the circuit described throughout the specification may be implemented in computer software, a custom built computerized device, a standard (e.g. off the shelf computerized device) and any combination thereof. Likewise, some embodiments of the present invention may contemplate a computer program being readable by a computer for executing the method of the invention. Further embodiments of the present invention may further contemplate a machine-readable memory tangibly embodying a program of instructions executable by the machine for executing the method in accordance with some embodiments of the present invention.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An audio processing circuit comprising:
a direct signal path;
an effect path, said effect path comprising:
a reverberation filter; and
a cross-talk cancellation filter adapted to receive an output of said reverberation filter directly or indirectly; and
an output adder adapted to receive and combine the output of said direct signal path and the output of said effect path.

2. The circuit according to claim 1, wherein each of said direct signal path and said effect path is adapted to receive an audio signal including two channels, and wherein each of said direct signal path and said effect path is adapted to output an audio signal including two channels.

3. The circuit according to claim 2, wherein each of said direct signal path and said effect path is adapted to receive a stereophonic signal, and wherein each of said direct signal path and said effect path is adapted to output a stereophonic signal.

4. The circuit according to claim 1, wherein said reverberation filter and said cross talk filter are connected in cascade.

5. The circuit according to claim 4, wherein said effect path further comprises a bandpass filter.

6. The circuit according to claim 5, wherein said bandpass filter is positioned between said reverberation filter and said cross-talk cancellation filter and is adapted to allow only a certain frequency range to pass through from said reverberation filter to said cross-talk cancellation filter.

7. The circuit according to claim 4, wherein said effect path further comprises a cross-over filter network.

8. The circuit according to claim 7, wherein said cross-over filter network is adapted to receive a signal from said reverberation filter and to allow only a certain frequency range to pass through to said cross-talk cancellation filter and to feed the remaining signal components to said output adder.

9. The circuit according to claim 1, wherein said cross-talk cancellation filter includes at least a dipole filter.

10. The circuit according to claim 1, wherein said effect path comprises a stereo widening filter, and wherein said stereo widening filter comprises at least said cross-talk cancellation filter.

11. The circuit according to claim 1, wherein said reverberation filter is adapted to create delayed replicas of an input signal.

12. The circuit according to claim 11, wherein the delayed replicas correspond to a simulated acoustical behavior of an input signal within an imaginary room.

13. The circuit according to claim 1, wherein said cross-talk cancellation filter is applied only to a signal arriving directly or indirectly from the reverberation filter.

14. The circuit according to claim 1, wherein said direct signal path is configured to allow an input signal to pass through the audio processing circuit substantially unaffected.

15. The circuit according to claim 1, wherein said direct signal path comprises a width matrix module.

16. The circuit according to claim 1, wherein said effect path further comprises one or more gains, and wherein said one or more gains are adapted to amplify and/or to attenuate the output of said cross-talk cancellation filter.

17. The circuit according to claim 1, wherein said effect path further comprises a mixer adapted to receive a stereophonic signal input and to compute a corresponding monophonic linear combination, and wherein said reverberation filter is adapted to receive from said mixer the monophonic linear combination and to produce stereophonic delayed replicas corresponding to the input monophonic linear combination.

18. An audio processing circuit comprising:
a first signal path configured to allow an input signal to pass through the audio processing circuit substantially unaffected;
a second signal path comprising:
a reverberation filter; and
a cross-talk cancellation filter adapted to receive an output of said reverberation filter directly or indirectly; and
an output adder adapted to receive and combine the output of said first and second signal paths.

19. The audio processing circuit according to claim 18, wherein each of said first and second signal paths is adapted to receive an audio signal including two channels, and wherein each of said first and second signal paths is adapted to output an audio signal including two channels.

20. A method of processing an audio signal comprising:
receiving an audio signal;
applying the audio signal to a direct signal path giving rise to a direct signal;
processing the audio signal giving rise to delayed replicas of the audio signal;
filtering the delayed replicas of the audio signal giving rise to an uncross-talked signal; and
combining direct signal and the uncross-talked signal.
